(19) United States
(12) Patent Application Publication
(10) Pub. No.: US 2023/0313698 A1
(43) Pub. Date: Oct. 5, 2023

(54) APPARATUS AND METHOD FOR A COMBINED HEAT AND POWER FACILITY

(71) Applicant: Leon Ciccarello, Pittstown, NJ (US)

(72) Inventor: Leon Ciccarello, Pittstown, NJ (US)

(21) Appl. No.: 18/129,337

(22) Filed: Mar. 31, 2023

Related U.S. Application Data
(60) Provisional application No. 63/325,765, filed on Mar. 31, 2022.

(51) Int. Cl. F01D 15/10; B01J 8/18

(52) U.S. Cl. CPC F01D 15/10; B01J 8/18; F05D 2220/76

(57) ABSTRACT

A system and method for a combined heat and power (CHP) is provided. One embodiment uses one or more modules that are scalable in size. Each CHP module cooperatively interacts with one or more of the other example CHP modules to provide heat, energy resources, and/or power to a small facility, such as a small business or residence. In some embodiments, the CHP system 100 can be scaled in size to accommodate the heat and power needs of multiple business facilities and/or residences.

### PRIORITY CLAIM

This application claims priority to copending U.S. Provisional Application, Ser. No. 63/325,765, filed on Mar. 31, 2022, entitled Apparatus And Method For A Combined Heat And Power Facility, which is hereby incorporated by reference in its entirety for all purposes.

### BACKGROUND OF THE INVENTION

Regional energy generation and distribution plans often utilize flawed design and delivery methods when applied to small scale energy projects. These plans are justified under an outdated theory that only large economies of scale can supply electricity to citizens. In fact, it is only now just becoming possible to create cost effective small scale energy projects to provide basic life-giving combined heat and power (CHP) capability, safety and low environmental impact.

Current electrical grids (each a “GRID”) are ineffective solutions for many types of small scale energy projects, and in particular, CHP projects. They absorb large tracks of land for large power generation equipment (often on waterfront properties) that causes environmental harm, and use highly inefficient transmission systems with significant danger of electrocution or combustion. Finally, because GRIDs link large numbers of households and businesses, any failure affects the health and welfare of disproportionate numbers of people.

Accordingly, in the arts of small scale energy projects, there is a need in the arts for improved methods, apparatus, and systems for providing more efficient, versatile and inexpensive small scale energy projects, and in particular, CHP projects.

### SUMMARY OF THE INVENTION

Embodiments of a CHP system comprise one or more modules that are scalable in size. Each CHP module cooperatively interacts with one or more of the other example CHP modules to provide heat, energy resources, and/or power to a small facility, such as a small business or residence. In some embodiments, the CHP system can be scaled in size to accommodate the heat and power needs of multiple business facilities and/or residences.

### BRIEF DESCRIPTION OF THE DRAWINGS

The components in the drawings are not necessarily to scale relative to each other. Like reference numerals designate corresponding parts throughout the several views.

FIG. 1 is a block diagram of a non-limiting example embodiment of a combined heat and power (CHP) system.

FIG. 2 is a block diagram showing greater detail of a non-limiting example embodiment of a CHP system.

### DETAILED DESCRIPTION

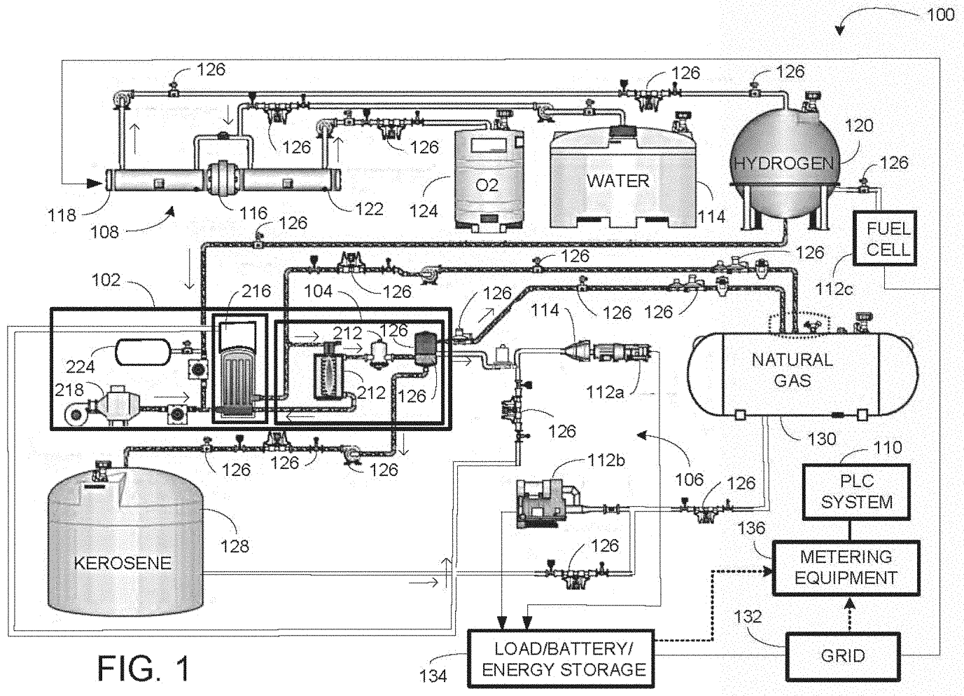

FIG. 1 is a block diagram of a non-limiting example embodiment of a combined heat and power (CHP) system 100. Embodiments of the CHP system 100 comprise one or more modules that are scalable in size. Each CHP module cooperatively interacts with one or more of the other example CHP modules to provide heat, energy resources, and/or power to a small facility, such as a small business or residence. In some embodiments, the CHP system 100 can be scaled in size to accommodate the heat and power needs of multiple business facilities and/or residences.

Embodiments of the CHP system 100 comprise a biomass burner module 102, a reformer module 104, an electric power generation module 106, an optional electrolysis module 108, a project logic controller (PLC) system 110, and various energy resource storage units. Embodiments of the CHP system 100 are configured to operate as a continuous flow system wherein input biomass materials are processed into other recoverable forms of energy, which may include heat and/or may include various hydrocarbon molecules that may be later “burned” for energy using another device.

In an example application, the CHP system 100 may provide power to a closed system to supply on demand power to a system load 134. Here, the system load 134 and the CHP system 100 are not electrically coupled to a legacy power grid 132. In this example application. Based upon detected actual demand, historical load demand data, and other system information acquired by the PLC system 110, the CHP system 100 may operate the biomass burner module 102 to generate various forms of energy that are converted into electricity that matches actual load demand. Heat from the biomass burner module 102 may be provided to the electric power generation module 106 to generate electricity. If insufficient energy is generated by the biomass burner module 102 to meet current load demand, previously generated stored fuels may be used to power the generators of the electric power generation module 106 to meet the current load demand. Alternatively, if the energy currently being produced by the biomass burner module 102 exceeds current load demand, then the biomass burner module 102 and/or the reformer module 104 may create fuel that is stored for later use.

In another example application, the system load 134 and the CHP system 100CHP system 100 may be electrically coupled to the legacy electric grid 132. Power flow may be monitored on a real time basis by the CHP system 100 using utility grade metering equipment 136 (which is also monitoring load requirements of the system load 134) that is communicatively coupled to the system load 134 and the PLC system 110. Depending upon operating instructions that are input to the CHP system 100, the CHP system may manage its energy resources to manage exchange of bower between the system load 134 and the power grid 132. For example, the CHP system 100 may generate electrical energy, and storable energy resources, so that net power flow between the system load 134 and the electric grid 132 is maintained at a near zero value. Alternatively, or additionally, the CHP system 100 may input power into the electric grid 132 at peak times, thereby generating revenue. Power may optionally be taken from the electric grid 132 at low peak times which grid power is less expensive. One skilled in the art appreciates that the operating scenarios between a CHP system connected to the electric grid 132 are limitless.

Distributed energy generation provided by an embodiment of a CHP system 100 can support one person or customer at a time at competitive costs, with much more safety and efficiency, and far less environmental impact, than legacy power and distribution systems. Embodiments of a CHP system 100 also allows power independence for habitats and even vehicles that can greatly reduce the carbon imprint of life and commerce.

Summarizing, embodiments of the CHP system 100 comprise a modular-based system that manages and generates power for energy on a local site to the local consumption or sale to outside loads. The CHP system 100 provides all energy needs and is economically viable with one user. It is also sustainable and is supported by local on-site resources. Embodiments of the CHP system 100 comprise a closed system with waste or by products remaining that only occur in nature and are benign and carbon neutral. Embodiments of a CHP system 100 utilize natural processes to convert and harness both latency and kinetic energy in its actual form and convert it to usable dispatchable resources to support local site loads.

The disclosed systems and methods for defining a suitable CHP system 100 for a particular facility will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for a CHP system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire based connector, whether directly or indirectly through a communication network 108. “Controllably coupled” means that an electronic device controls the operation of another electronic device.

The objectives and points of novelty below describe novel design and configuration of a self-contained CHP system 100, with various CHP modules comprising power systems and system elements for generating electrical power, energy resources, and heat. They employ, in turn, certain novel configurations, novel internal interactions, and novel external interactions to interface with components of existing GRID electrical transmission, sale and power injection. module 102

The reformer module 104 portion of the CHP system 100 operates based on a fluidized bed reactor (FBR) principle. The biomass burner module 102 portion of the CHP system 100 receives any suitable biomass material to be used as the solid substrate material for the various chemical reactions that occur within the CHP system 100. Any suitable biomass material may be used, alone or in combination. For example, but not limited to, the biomass material may be wood chips, waste food (plant and/or animal matter), waste paper products, compostable materials, commercial pellets, or the like.

The electric power generation module 106 portion of the CHP system 100 may power one or more of the electrical generators 112 that are used to generate electrical power that is delivered to an electrical load 134 for immediate use and/or to an energy storage device, such as a battery, salt solution, capacitor, etc. Accordingly, the CHP system 100 may include one or more electrical generators.

Embodiments of the CHP system 100 that generate steam may employ a steam turbine 114 that powers a generator 112a. Multiple high pressure and low pressure turbines 114 may be used depending upon the steam characteristics of the generated steam. Alternatively, or additionally, some embodiments may employ a turbine 114 that operates using another low pressure/temperature working fluid, such as turbines known in the arts of geothermal energy production or in the arts of cogeneration technologies. Alternatively, or additionally, some embodiments may employ a turbine 114 that is configured to receive and burn a liquid fuel, such as, but not limited to, hydrogen. The fuel, which may be a gas or a liquid, is preferably created by the CHP system 100 as a byproduct of the processing of the biomass material. Any suitable turbine 114 and associated generator 112 know known or later developed are intended to be included within the scope of this disclosure and to be protected by the accompanying claims.

The electrolysis module 108 portion of the CHP system 100 may employ electrolysis to create oxygen and hydrogen from water. For example, water stored in the water storage container 114 may be injected into the electrolysis vessel 114. Electrical power provided by the electric power generation module 104 may be provided to the electrolysis vessel 116 so that the water is split into hydrogen atoms and oxygen atoms. Hydrogen is extracted from the cathode 118 and is transported to the hydrogen storage vessel 120. The generated hydrogen may be used for a variety of purposes for later use.

FIG. 1 conceptually illustrates that hydrogen may be transported to the biomass burner module 102. Hydrogen may be used to facilitate the processing of the biomass material. Alternatively, or additionally, if electrical power is needed, then the hydrogen may be transported to a turbine 114 configured to burn hydrogen, and/or to a fuel cell 112b, to generate electrical power. An unexpected advantage provided by embodiments of the CHP system 100 is that electricity generated during biomass processing may be used by electrolysis module 108 to generate hydrogen. The hydrogen can be later used to generate electricity when needed (on demand). Even though the process of creating hydrogen from electricity, and then later generating electricity from the hydrogen, may be lossy (energy inefficient), the timing difference between the hydrogen generation and the use of the hydrogen to generate electricity may be cost effective in view of the legacy power generation and delivery costs that may be otherwise charged to the user of the CHP system 100 when electrical power is received from the electric grid 132. Further, if no electric grid 132 is available at the location of the CHP system 100, the use of the generated hydrogen to create electrical power when needed may be an opportunity to the user of the CHP system 100 to have access to electrical power on demand. Hydrogen may also used as a base molecule to create other hydrocarbon based fuels. For example, but not limited to, the generated hydrogen may be further processed by the CHP system 100 to generate CH4 Natural Gas. Alternatively, or additionally, further synthetic conversion by the CHP system 100 may be used to generate DME (Dimethyl Ether), Fischer Trospch Diesel (referred to herein as diesel), or the like.

During the electrolysis process, oxygen is extracted from the anode 122 and is transported to the oxygen (O2) container 124. The oxygen may be a valuable resource or commodity to the user of the CHP system 100. For instance, the user may sell the oxygen. In some embodiments, the oxygen may be transported to the biomass burner module 102 and/or the reformer module 104 to facilitate the processing of the biomass material.

The PLC system 108, based on sensed current operating information, electrical load characteristics, power exchange to or from an electric grid 132, and user provided information, controls a plurality of pumps, flow valves, control valves, check valves and other electro-mechanically controlled fluid control devices 126. The fluid control devices 126 are controllably coupled to the PLC system 108. For convenience, selected fluid control devices 126 are illustrated in FIG. 1. For brevity, not all fluid control devices 126 are illustrated in FIG. 1. However, one skilled in the art appreciates where the plurality of fluid control devices 126 need to be located, and how and when such fluid control devices 126 are actuated, to implement embodiments of the CHP system 100. The fluid control devices 126 may control flow of liquid fluids and/or gas fluids. Any suitable PLC system 108, and the corresponding controlled fluid control devices 126, now known or later developed, are intended to be included within the scope of this disclosure and to be protected by the accompanying claims.

As disclosed herein, the reformer module 104 portion of the CHP system 100 operates based on a fluidized bed reactor (FBR) principle. Embodiments of the CHP system 100 are configured to selectively control the FBR chemical reactions in a controlled manner such that the various outputs of the CHP system 100 are comprised of intended energy types.

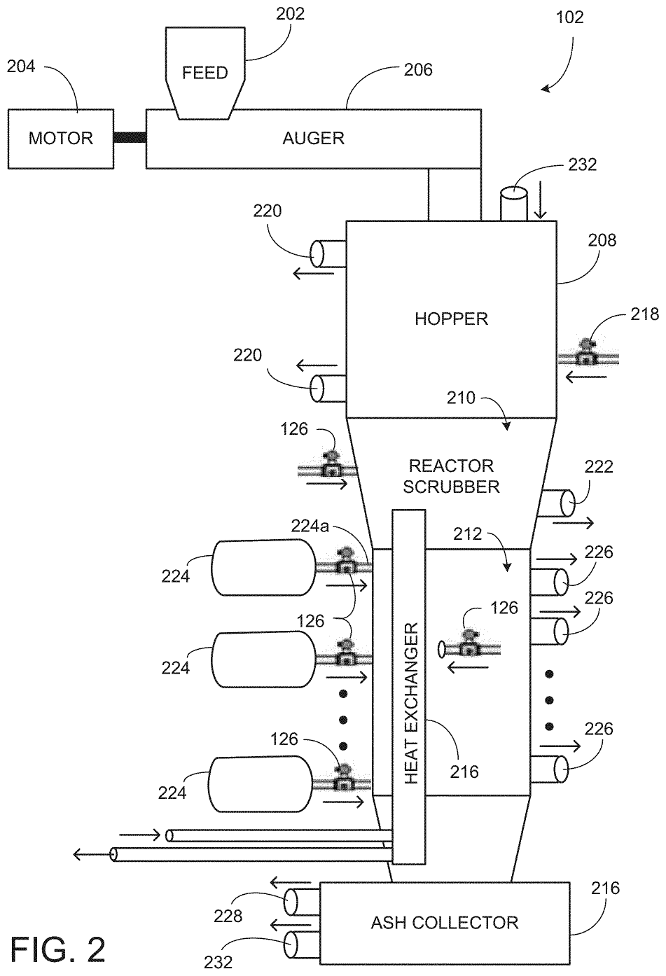

FIG. 2 is a block diagram showing greater detail of a non-limiting example embodiment of a CHP system. The illustrated biomass burner module 102 and reformer module 104 comprise a feed 202, a motor 204, an auger 206, a hopper 208, a reactor scrubber 210, a fluidized bed reaction container 212, an ash collector 214, and an optional heat exchanger 216.

Biomass materials are fed into the feed 202. Preferably, the biomass material is in a processed form for use within the CHP system 100. For example, wood may be processed into smaller wood chips. Small pellets may be used. Paper and other similar materials may be shredded. Food waste may be ground. It is appreciated that a mixture of different types of biomass material may be used, even concurrently.

The motor 204, under the control of the PLC system 110 (FIG. 1), turns an auger 206 to transport the input biomass into the hopper 208. As the stream of biomass material moves downward through the hopper 208, various chemical reactions may begin. Fluids and/or gases may be introduced, via inlet(s) 218, into the hopper 208 to facilitate initiation of the various chemical process that occur in the hopper 208. Control of introduced fluids and/or gases via the one or more inlets 218 may be managed by the PLC system 110. In some embodiment, sensors (not shown) located within the hopper 208 may be used to provide data inputs that are used by the PLC system 110 to control the inlets 218. Such sensors may sense temperature, pH level, acidity or alkalinity levels, or for presence of specific chemicals. Any suitable parameter of interest may be detected by the sensors.

Byproduct gases of the chemical reaction occurring in the hopper 208 may be extracted from one of the hopper outlets 220 located along the length of the hopper 208. A plurality of outlets 220 may be arranged along the length of the hopper 208 since different types of byproduct gases may be generated at different locations along the hopper 208. Control of extracted gases may be managed by the PLC system 110. In some embodiments, sensors (not shown) as noted herein that are located within the hopper 208 may be used to provide data inputs that are used by the PLC system 110 to control the inlets 218.

As the biomass passes through the reactor scrubber 210, the processing biomass generates conventionally undesirable gasses. In legacy biomass burning systems, these undesirable gases are transported into a conventional scrubber that removes particulates and/or other chemicals. However, embodiments of the CHP system 100 recognize that these gases may have valuable properties. Accordingly, the gases are extracted, via the outlet 222 (rather than being transported to a conventional scrubber stack or system). In an example embodiment, the extracted gases are processed by the reformer module 104 (FIG. 1) into various types of energy resources.

As the stream of reacting biomass material passes through the reactor scrubber and through the fluidized bed reaction container 212, additional chemical reactions are induced within the fluidized bed reaction container 212. To facilitate the various chemical reactions occurring in the fluidized bed reaction container 212, a plurality of catalysts are injected into the fluidized bed reaction container 212. In an example embodiment, a plurality of catalyst containers 224 are arranged along the length of the fluidized bed reaction container 212 so that particular catalysts are introduced into the interior of the fluidized bed reaction container 212. Control of introduced catalysts may be managed by the PLC system 110. In some embodiments, sensors (not shown) as noted herein that are located within the fluidized bed reaction container 212 may be used to provide data inputs that are used by the PLC system 110 to control the input of the catalysts, as conceptually illustrated in FIG. 2. In some embodiments, a single catalyst container 224 may store a catalyst that is introduced at multiple locations, and/or at different times, along the length of the fluidized bed reaction container 212. Accordingly, a plurality of different catalyst inlets 224a, each controlled by a fluid control device 126, may inject desired amounts of the catalyst and desired times to control the ongoing reaction process within the fluidized bed reaction container 212.

Different catalysts can be introduced into the fluidized bed reaction container 212 at different times during a biomass burn process, or a different biomass burn process, such that different energy source fluids are generated at different times. For example, hydrogen may be generated at a first time using a first catalyst, and diesel may be generated as a second different time using a different second catalyst.

Fluids of interest, interchangeably referred to herein as energy source fluids, are generated within the fluidized bed reaction container 212 during the reaction process as the biomass materials move down through the fluidized bed reaction container 212. These fluids of interest may be in liquid form or gas form. The generated fluids of interest are extracted at one or more outlets 226. These extracted fluids are energy resources, or may be used to generate energy resources.

For example, kerosene may be a generated fluid that is extracted out one or more of the fluidized bed reaction container outlets 226. In practice, selected catalysts configured to generate kerosene may be injected from one or more of the catalyst containers 224. By managing catalyst injection, and/or operating conditions such as temperature or the like, the CHP system 100 can be operated purposely to generate kerosene. The extracted kerosene can then be transported to and stored in a kerosene storage tank 128 (FIG. 1). As another example, natural gas may be generated and extracted based on control of input catalysts and/or by control of various operating parameters. The extracted natural gas may be transported to and stored in a natural gas storage tank 130. In some embodiments, during a biomass patter burn process both natural gas and kerosene may be concurrently generated, or alternatively generated, and stored by the CHP system 100.

Different kinds of fluids may be generated at different locations along the fluidized bed reaction container 212. Accordingly, a plurality of outlets 226 may be located along the length of the fluidized bed reaction container 212. Each of the outlets is managed by the PLC system 110 that controls operation of fluid control devices 126 (not shown) on each of the outlets 226. In some embodiments, sensors (not shown) as noted herein that are located within the fluidized bed reaction container 212 may be used to provide data inputs that are used by the PLC system 110 to control the outlets 226.

As the processed biomass solids finish passing through the fluidized bed reaction container 212, the solids are passed to the ash collector 216. Gases may be extracted from the outlet 228 of the ash collector 216 for further processing. In some embodiments, the extracted gases are transported and injected back into the biomass burner module 102 and/or the reformer module 104, as conceptually illustrated by the inlet 230. Such inlets 230 may be located at any desired location along the biomass burner module 102, the hopper 208, and/or the reformer module 104 based on the nature of the chemicals in the gases exiting from the ash collector 216.

Similarly, the ash itself may have various materials or properties of interest. For example, the biomass material may not have been completely processed (burned, oxidized, etc.). Accordingly, in some embodiments, the ash is transported and injected back into the biomass burner module 102, as conceptually illustrated by the inlet 230. Such inlets 230 may be located at any desired location along the biomass burner module 102 based on the nature of the chemicals in the ash exiting from the ash collector 216.

Summarizing, the biomass burner module 102, interchangeably referred to herein as a fire box module, has the capability to burn or oxidize biomass materials with a carbon foundation. The fire box module design is one that processes the biomass material in a computer-controlled environment utilizing stoichiometry systems and real time calculations. The CHP system 100 is condensing and non-condensing based on computer control of needed resources. It maintains a gasification of material while limiting the creation of Nitric Oxide and Sulfur Dioxide. This controls a stack exhaust of Carbon Dioxide water vapor and marginal particulate as it has been captured in the ash tray 216 by design. The stack output can be captured for another module to create additional generation, heat and by products. The fire box module burner is multi firer box stacked gasification exhaust system. Any suitable biomass material, such as wood chips, pellets or biomass products may be used. Natural Gas, Propane and DME may also be used to facilitate the catalyzation process. The autoignition system managed by the PLC system 110 regulates the use of biomass to meter the stored BTU's (British thermal units) per volumetric calculation off set by lambda, pressure and temperature values and generated kwh against fuel product in the burner. Pellets are the preferred method to fire the system in an example embodiment. But embodiments are not limited to one fuel type. The fire box module burner 102 is comprised of multistage path ways and operates by secondary burn of released gases, the final stage is condensing to drive efficiency and limit exhaust temperatures. Efficiencies of the fire box module may exceed 110%

In an example embodiment, the heat byproduct is absorbed by a thermal medium and passed through one or more heat exchangers 216. The heated working fluid that is heated in the heat exchanger 216 is transported downstream to be used as work product on other stages. For example, the heated working fluid may be used to drive a low pressure turbine 114, and/or to vaporize another working fluid used by the low pressure turbine 114.

For example, the electric power generation module 106 may comprise a generation stage, fronted by an axial turbine, followed by an axial wobble offset drive swashplate with cascading expanders with the final stage condensing and absorbing all the heat energy and converting it to kinetic energy. This configuration is completely configurable to operate using any torque and/or horsepower of interest. This configuration also can negate the need for a cooling stage to return the condensate back to the start of the process to generate kinetic force. When a low heat system is utilized the steam as a working fluid may be replaced by a refrigerant.

As noted herein, embodiments of a reformer module 104 employ a catalyst reformer stage. By sequestering the CO2 in the form of a hydrocarbon fuel, the reformer module 104 extracts an additional 55% energy generation by mole count from the burn stage of the biomass material. The additional heat can be processed by the same stage generation expander to derive more energy. The output can be stored for future use or burned in real time to double the face plate output of the system. The storage medium is at atmospheric pressure, with no exposure to handling difficulties, mitigated environmental impact if spillage occurs, and ability to use lower cost components (non-high pressure components).

In the various embodiments, the hardware control system module, interchangeably referred to herein as the PLC system 110, provides for electrical priority resource management. The hardware control system module 110 may employ a DC (direct current) managed bus system. AC (alternating current) power may be optionally made at time of use. Power factor may be regulated electronically for optimization. Batteries and Capacitors may be deployed to provide instantaneous current to match the load 134. Generation resources are called on a priority of depth of discharge against the recharge ramp rate by fuel or resource cost. Solar and wind units may also be mapped resources in the available source and be synchronized with the system recovery of the CHP system 100. Time to system depletion may also be tracked against resources on hand and predictive generation by way of potential green generation by the PLC system 110. The dynamic addition of resources may be fluid, and can be reconfigured on a real time basis to provide additional capability as needed.

Functionality of a non-limiting exemplary embodiment of a CHP system 100 may include a burner that doubles as an oxidizer, ahead of a number of baffles and exhaust plumbing that is modulated through a call for heat or power to perform to a specific set of programmatic routines to extract the best result in load coverage utilizing the lowest cost to do so. Through a software control tied to a programmable logic controller the PLC system 110 that directs the resources to track it performance against the load, the economic cost of the resource and the environmental impact of utilizing that particular resource can be optimized.

The biomass burner module 102 starts with biomass. The feed of the biomass matter is automatically controlled based on measured weight, volume, and moisture content. The controlled burning process of the biomass matter is managed utilizing a number of lambda sensors with temp and pressure sensors. The burn is calculated against BTU's needed the expected burn ramp rate based on moisture and the desired output driven to cover a heat load and power requirement both real time and in replacement of quantity of storage on hand. The exhaust is pure carbon dioxide (CO2) with little or no particulate present in the stream. The output is either sent to the reformer module 104 that converts the CO2 to a hydrocarbon fuel, or may be stored for later use to do the same. This reaction is exothermic, so it is utilized when addition generation and heat are required to meet the load 134. In this config there is no emissions from the system. The burn is further enhanced by the addition of gas trains to provide additional btu's on a peak need basis, and/or to burn off storage if levels are reaching 100% in the storage tanks.

The CHP system 100 starts with a steady state of a known kwh of available generation to meet a load 134. The software through a shadow settlement system increments and decrements the tally to keep the system ahead of the predicted load. During a burn cycle the btu's are allocated against real load, recharging of a local battery store, and/or the conversion of heat to hydrocarbon storage for later use. If the burn was started the system works to move the energy into a latency position if not used to cover real time load. The software manages the system's Direct current first. Utilizing electronic inverters to produce the electric to cover load 134 in real time. The system is matched to the load centers and is designed to provide 100% of the current for a realistic run time. The dispatch allocation shadow settlement logic system balances the system's ability to recover and to restore system resources based on the economic cost against kwh. But always maintaining the longest ramp run rate to produce power to cover the predictive load. At the heart of the system is the generation system. Designed to either be driven by low grade steam or by a refrigerant working fluid if the install is utilizing a heat source not under its control and is below steam temperature. These head units are arranged in an axial sinusoidal configuration. The timing is controlled by the logic controller of the PLC system 110.

In an example embodiment, the armature of the motor 204 is arranged in a multi cylinder configuration in a polar array to the main drive shaft but with an offset to replace the need for a crank shaft. This allows for perfect balance, the drive unit always runs in one direction and it can be throttled by means of regulating both flow and pressure to match the generation to the burn rate against the load needs. This configuration also allows for maximum torque that build with each revolution as the configuration is bolstered by the speed and pressure of its downstream cylinder. It can rev much faster and be throttled back in two or three revolutions. This makes the low mass axial engine responsive to the load requirements in real time. This also allows for multiple units to be ganged together to scale up and scale down as a unit. It also allows for failure as the loop to spin up or down is against the need and not on a specific number of head units. This makes the system resilient and self-healing and can utilize any number of installed head configs. Other resources may be added without impacting the design or performance of the system, solar, wind, other gen sources only add to the round robin approach to load coverage.

The PLC system 110 may optionally provide energy management system reports, manages, and automates energy use. It has a distributed architecture and an adaptive set of models that give it the power to build a comprehensive system that will save energy, money and reduce carbon emissions. In a preferred embodiment, there are three major functions that the PLC system 110 performs: monitoring, analysis and automated control. In addition, the PLC system 110 is flexible and, thanks to its modular architecture, can be expanded to communicate with and control new types of devices as they become available.

In a preferred embodiment, the PLC system 110 is based upon a distributed architecture model. The PLC system 110 functions equally well in residences, single commercial building and globe-spanning enterprises. Each PLC system 110 node can act autonomously, yet will also cooperate with other nodes in a tree-like structure. This means that installations can begin with a single instance of the system in a single location and can grow seamlessly into a fully cooperative system by adding additional system nodes.

Each system Node of an example PLC system 110 may be comprised of the following: a system Device Interface, a system Database, a system Engine, and a system User Interface.

The system Device Interface is how the PLC system 110 communicates with the devices that are monitored and controlled such as thermostats, chillers, etc. The system Device Interface is based upon the adapter model which allows for easy expansion to new devices as they become available. The PLC system 110 uses industry-standard communication methods including Ethernet, RS-232, RS-422 and RS-485 as well as wireless communications including mesh networks such as Zigbee and Z-Wave. Any combination of these can be combined in a single the system node installation.

The database is amorphic by design. The system data model is comprehensive and expandable. The system database stores data returned by the devices, control information for the devices, schedules, environmental data (weather, solar gain, etc.), market data (energy pricing, carbon-cost data) as well as reference data for devices (model, manufacturer, published performance specifications, etc.) and reference data for the installation (physical location, contact names, etc.). Finally, the system database stores the adaptive logic that supports the powerful predictive capabilities of the system engine.

The system engine gathers and analyzes data from the devices and environmental conditions and makes predictions and recommendations. The system engine makes use of state-of-the-art models into which the data is fed. The results are weighted by user-defined parameters to determine the optimum strategy. A combination of user-defined parameters is used to weight the resulting strategies. Users can set the precedence of comfort, cost, carbon production and energy conservation. These settings can be applied to each system node and can be set for specific schedules. For example, it is possible to set a priority on energy savings with a secondary priority of comfort for 12 PM to 2:30 PM, and then specify a different set of priorities for the period from 2:30 PM to 5 PM. There is no limit the number of different strategy schedules that can be created.

The system engine is adaptive. As real-world data is accumulated, the system engine applies what it has learned to the models it uses to make predictions. Each time the system engine makes a prediction, the result of using that prediction is scored and, over time, adjustments are made that improve the operation of the models.

The system engine communicates with other the system instances. This allows the designation of one or more system nodes as masters that control other groups of the system nodes. This makes it possible to make system-wide changes to settings or behavior. In addition, master nodes can gather and consolidate data from other the system nodes to facilitate system-wide reporting and strategizing.

The system engine is secure. All data communicated by the system engine is encrypted.

The system User Interface (UI) is how users control and access the system. The system UI includes both a web-based and native-client interface. The system UI interface is configured so that it presents a consistent, situationally correct view of the system. For example, where a system node is running on a single-board computer, the interface provides a touchscreen. For larger installations, the web-based interface can be used. The web-based interface allows the system to be controlled from anywhere in the world, even over portable devices such as a smart phone or the like.

The PLC system 110 retrieves the carbon cost associated with the energy used by the monitored devices and creates and maintains an accurate, real-time assessment of the carbon footprint of each and every device. This provides the ability to know how much carbon your device, building or organization is producing. As a result, the system users can: evaluate energy sources in real-time, track carbon cost, and/or participate in carbon-trading programs.

The flexible architecture of the CHP system 100 will allow future integration into carbon-trading systems. This will allow the creation of comprehensive carbon-management strategies which would include trading carbon usage between different the system users, even across companies.

The CHP system 100 provides full support for demand response. The CHP system's intelligent engine allows user to create comprehensive strategies to respond to curtailment events that optimize operation for any of the selectable parameters. In short, rather than having a set response of disabling one or more energy-consuming devices blindly, the system users can define desired goals that are time and user-sensitive. By considering environmental and other conditions, the system can maintain higher levels of comfort and business functionality during curtailment events.

In addition, the comprehensive monitoring by embodiments of a CHP system 100 provides hard data that allows users to evaluate the impact of curtailment events upon business operation.

It should be emphasized that the above-described embodiments of the CHP system 100 are merely possible examples of implementations of the invention. Many variations and modifications may be made to the above-described embodiments. All such modifications and variations are intended to be included herein within the scope of this disclosure and protected by any later filed claims.

Summarizing features and benefits, embodiments of a CHP system 100 provide for an economic transaction with one person's energy needs being supplied locally and supported by one economic means. Embodiments of a CHP system 100 provide all the energy needs of a residence or business: electric, hydrocarbon fuels, heat, cooling, waste disposal and water purification. Embodiments of a CHP system 100 conserve resources and only produces the energy needed to support a local need. Embodiments of a CHP system 100 are expandable to support additional resources both passive and active. Embodiments of a CHP system 100 will store energy in many forms to provide freedom of action and flexibility to outside constraints. Embodiments of a CHP system 100 are comprised of modular parts allowing replacement, retrofit and augmentation without disturbing other modules. Embodiments of a CHP system 100 will interact with public and private dispatch, curtailment, load sharing and aggregation systems. And will provide shadow settlement and financial accountability in real time. Embodiments of a CHP system 100 are not tied to any fuel or generation type. Embodiments of a CHP system 100 will operate within acceptable local operational attributes and parameters. Embodiments of a CHP system 100 may be sustainable with only local resources. Embodiments of a CHP system 100 are dispatchable to load and supply requirements. Embodiments of a CHP system 100 comprise one or more CHP modules that have throttleable heat output. Embodiments of a CHP system 100 use CHP modules comprised of microprocess controlled systems and subassemblies all tied to a controller for scheduling and direction of process. Embodiments of a CHP system 100 will tie and support to existing mechanicals of the installed site facilities. Embodiments of a CHP system 100 auto configures to resources on hand. Embodiments of a CHP system 100 auto heals for outages and depleted resources. Embodiments of a CHP system 100 can auto-adapt to new resources and fuel stores on a real time basis. Embodiments of a CHP system 100 provide energy independence to a given geographic site and/or load, thus providing energy independence from a common electric grid 132. Embodiments of a CHP system 100 are organized in self-contained modules that perform discrete tasks independently.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Therefore, having thus described the invention, at least the following is claimed:

1. A combined heat and power (CHP) system, comprising:
a biomass burner module that burns a received stream of biomass material;
a fluidized bed reaction container configured to receive the streaming biomass material from the biomass burner, wherein the fluidized bed reaction container comprises:
a catalyst container that contains a catalyst;
a catalyst inlet that receives the catalyst from the catalyst container, wherein the catalyst is injected into the fluidized bed reaction container via the catalyst inlet;
a fluidized bed reaction container outlet that transports an energy source fluid that is generated by a reaction between the catalyst and the biomass matter received from the biomass burner module out from the fluidized bed reaction container;
a storage unit that is fluidly coupled to the fluidized bed reaction container outlet;
an electric power generation module that is fluidly coupled to the fluidized bed reaction container outlet, wherein electric power is output to a system load; and
a project logic controller (PLC) system,
wherein the PLC system is controllably coupled to a first fluid control device that is fluidly coupled between the fluidized bed reaction container outlet and the storage unit,
wherein the PLC system is controllably coupled to a second fluid control device that is fluidly coupled between the fluidized bed reaction container outlet and the electric power generation module, and
wherein the PLC system is communicatively coupled to the system load via metering equipment,
wherein the PLC system actuates the first fluid control device to transport a first portion of the energy source fluid to the storage unit based on a metering of the system load, and
wherein the PLC system actuates the second fluid control device to transport a second portion of the energy source fluid to the electric power generation module such that the electric power generation module generates an amount of power corresponding to a current power demand of the system load.

2. The CHP system of claim 1, further comprising:
a pump that is fluidly coupled between the electric power generation module and the storage unit, and that is controllably coupled to the PLC system,
wherein the PLC system actuates at least one of the first fluid control device and the second fluid control device to transport the first portion and the second portion of the energy source fluid to the electric power generation module in response to the current power demand of the system load exceeding the amount of electric power generated by the electric power generation module using the energy source exhausted from the reformer module,
and wherein the PLC system actuates the pump to transport additional energy source fluid stored in the storage unit to the electric power generation module,
wherein the amount of electric power generated by the electric power generation module using the energy source fluid transported from the fluidized bed reaction container and the additional energy source fluid received from the storage unit increases the amount of electric power generated by the electric power generation module to match the current power demand of the system load.

3. The CHP system of claim 1, wherein the energy source fluid transported from the fluidized bed reaction container is hydrogen, and wherein the electric power generation module comprises:
a generator that generates the amount of electric power using the hydrogen.

4. The CHP system of claim 1, wherein the energy source fluid exhausted from the fluidized bed reaction container is diesel, and wherein the electric power generation module:
a generator that generates the amount of electric power using the diesel.

5. The CHP system of claim 1, wherein the energy source fluid transported from the fluidized bed reaction container is a first energy source fluid, wherein the storage unit is a first storage unit, wherein the fluidized bed reaction container outlet is a first fluidized bed reaction container outlet, and further comprising:
a second fluidized bed reaction container outlet that transports a second energy source fluid that is generated by the reaction between the catalyst and the biomass matter in the fluidized bed reaction container,
wherein the first energy source fluid is different from the second energy source fluid,
wherein the PLC system is controllably coupled to a third fluid control device that is fluidly coupled between the second fluidized bed reaction container outlet and a second storage unit, and
wherein the PLC system actuates the third fluid control device to transport the second energy source fluid to the second storage unit.

6. The CHP system of claim 5, wherein the first energy source fluid is hydrogen, wherein the second energy source fluid is diesel, and wherein the hydrogen is generated at a first time and the diesel is generated at a second time that is different from the first time.
